(19) United States
(12) Patent Application Publication
(10) Pub. No.: US 2005/0043097 A1
(43) Pub. Date: Feb. 24, 2005

(54) Interrelated game and information portals provided within the context of an encompassing virtual world

(75) Inventors: Scott A. March, Coppell, TX (US); David H. Jones, Roanoke, TX (US)

Correspondence Address: COX SMITH MATTHEWS INCORPORATED, 112 EAST PECAN STREET, SUITE 1800, SAN ANTONIO, TX, 78205-1521, US

(73) Assignee: Spidermonk Entertainment, LLC

(21) Appl. No.: 10/924,182

(22) Filed: Aug. 23, 2004

Related U.S. Application Data
(60) Provisional application No. 60/496,752, filed on Aug. 21, 2003.

(51) Int. Cl. G06F 17/00; G06F 19/00

(52) U.S. Cl. 463/42

(57) ABSTRACT

A method and system is provided for a virtual game world in which multiple players may play a plurality of games. Each player has a persistent and dynamic virtual identity that is relevant to and affected by the player's activity in each of the games. The games provide the opportunity for the various players to interact with each other, regardless of the actual physical location of the respective players. Preferably, the games provide the opportunity for players to cheat, including conspiring to cheat among multiple players, and accuse other players of cheating. Cheating and accusation of cheating may have positive or negative consequences to the respective players. The games, which are located at specific locations in the virtual world, are preferably provided with location-specific information from corresponding locations in the real world.

### CROSS-REFERENCE TO RELATED APPLICATION

This application claims the benefit of U.S. Provisional Patent Application Ser. No. 60/496,752 filed on Aug. 21, 2003, the full disclosure of which is incorporated herein by reference.

### BACKGROUND OF THE INVENTION

In the field of electronic games, there are a number of needs for improvement, including the following:

(a) users need a user interface which provides an engaging and intuitive method of navigating to and accessing a variety of multi-player game portals;

(b) a need for companies in an incredibly competitive market to be able to attract and engage players of networked multi-player games into a single common encompassing virtual game environment of their endeavor which provides users a single access point to a variety of networked multi-player games;

(c) a need for a mechanism for making multi-player games more meaningful and engaging for players, relating them to more than just a quick isolated game or high score tables, so that players will be more inclined to play and to play more often;

(d) a need to make multi-player games more practical for all players when some of those who are playing play from mobile phones, which are prone for interruptions such as incoming phone calls, dropped calls, or roaming out of coverage;

(e) a need for a mechanism that allows more elements of realism into the game play;

(f) a need for a mechanism that allows the game play element of cheating to be provided in a practical and engaging way during multi-player game play;

(g) a need for users to have a process which simplifies and streamlines the tasks of purchasing, registering, obtaining and accessing a wide variety of game portals;

(h) networked game players playing from their mobile devices are especially prone to network interruptions due to receipt of incoming phone calls or intermittent wireless network coverage, and games need to provide ways for such interruptions to be handled gracefully.

### SUMMARY OF THE INVENTION

The present invention addresses the foregoing needs by providing an encompassing virtual game world, preferably with the following features:

(a) many portals to a variety of multi-player games are contained within a larger ongoing game and game world such as that of a role playing game;

(b) the sub games and the encompassing games are tied in together contextually, adding more relevance to the variety of games when played;

(c) the present invention simplifies and streamlines the process for users to purchase, register, obtain and access a wide variety of game portals;

(d) the present invention attracts and engages players of various types of networked multi-player games into a common encompassing game environment, which provides more attention and sales for the game provider;

(e) multi-player games can be accessed by navigating to various locations within the game world and within the context of an ongoing game;

(f) the new game dimension of cheating in multi-player games is enabled;

(g) non-player characters can step in for multi-player game players that were dropped out due to wireless network interruption during the game play in order to minimize the inconvenience for other players, and the dropped players are provided a method to rejoin the game should network connection be resumed and the game still be in progress;

(h) the present invention attractively enables cheating and its consequences to multi-player games, which adds a new dimension to game play;

(i) the action of locating the various game lobbies includes navigating through the virtual game world, thereby making the function of locating a game lobby intuitive as well as providing additional dimensions to the game play itself;

(j) location-specific elements of the real world are reflected back into the virtual game world during game play.

### BRIEF DESCRIPTION OF THE DRAWINGS

FIG. 1 is a schematic block diagram of a game system in accordance with the present invention.

FIG. 2 is a schematic diagram of a Player Type enumeration in accordance with the present invention.

FIG. 3 is a schematic Game Player State class diagram in accordance with the present invention.

FIG. 4 is a schematic Game Player Instance class diagram in accordance with the present invention.

FIG. 5 is a schematic Server Game Type Interface class diagram in accordance with the present invention.

FIG. 6 is a schematic diagram of a Leave Code Type enumeration in accordance with the present invention.

FIG. 7 is a schematic Game World Context Interface class diagram in accordance with the present invention.

FIG. 8 is a schematic block diagram of a Server Game-Type Module of FIG. 1.

FIG. 9 is a schematic Client Game Type Interface class diagram in accordance with the present invention.

FIG. 10 is a schematic block diagram of a Client Game-Type Module of FIG. 1.

FIG. 11 is a country level representation of a graphical user interface in accordance with the present invention.

FIG. 12 is a street level representation of a graphical user interface in accordance with the present invention.

FIG. 13 is a building level representation of a graphical user interface in accordance with the present invention.

FIG. 14 is game room level representation of a graphical user interface in accordance with the present invention.

FIG. 15 is a game portal representation of a graphical user interface in accordance with the present invention.

FIG. 16 is another view of a game portal representation of a graphical user interface in accordance with the present invention.

FIG. 17 is a flowchart of a Server Game-Type Game Play Engine of FIG. 8 illustrating a cheating process in accordance with the present invention.

FIG. 18 is a flowchart of the Process Cheating Attempt of FIG. 17.

FIG. 19 is a flowchart of the Process Accusation Attempt of FIG. 17.

### DETAILED DESCRIPTION OF THE PREFERRED EMBODIMENT

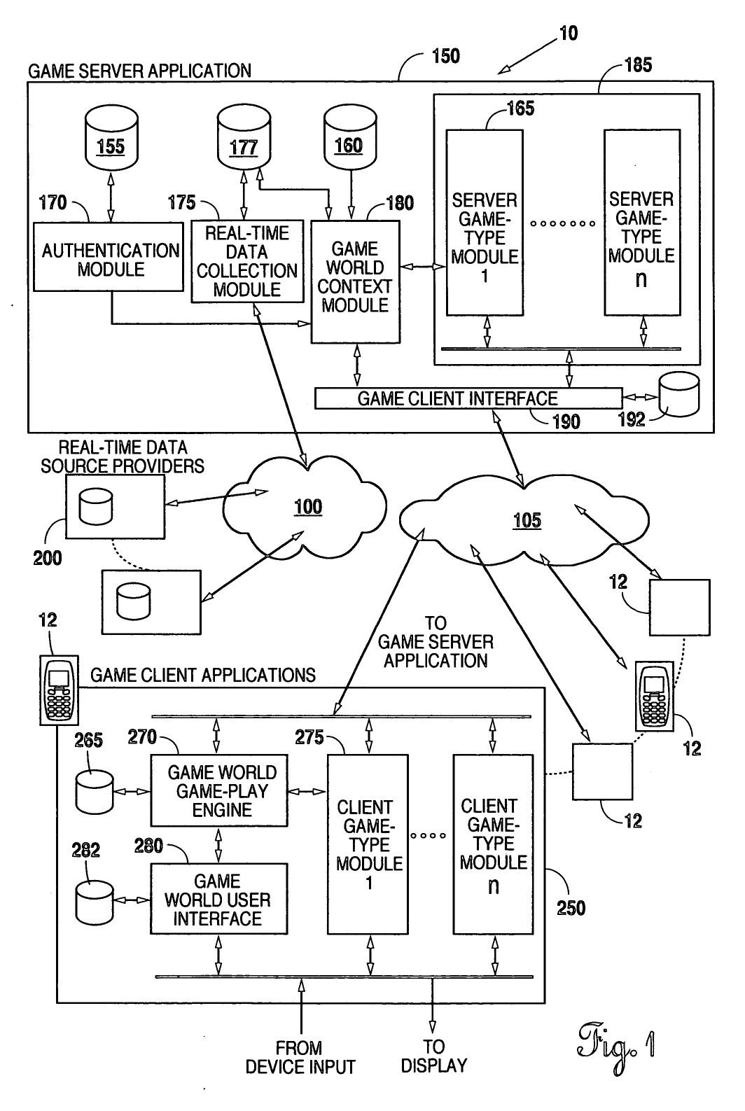

Referring to FIG. 1, there is shown a schematic representation of a multi-player game system 10 which preferably comprises at least one networked computer (not shown) running an instance of a Game Server Application (GSA) 150 interconnected by a network 105 with a plurality of networked devices 12 simultaneously running an instance of a Game Client Application (GCA) 250. The GSA 150 is the centralized element of the multi-player game that maintains all of the common aspects of a virtual game world (the Game World) and allows the plurality of GCAs 250 to interact with it. The GCAs 250 display to the users the visual elements of the game and process their input allowing them to interact with the game and other players by ongoing communication with GSA 150 over network 105. The GSA 150 and the GCAs 250 are executable applications which may be programmed and compiled into executable object code for a number of different operating systems and devices that provide network connectivity, such as general purpose computers, server machines, regular Personal Computers, Smartphones, regular Mobile Phones, Personal Digital Assistants, game consoles, and similar digital processing devices, all of which are referred to herein as computer processors. The computer processor on which the GSA 150 resides is referred to herein as a server computer, and the computer processors on which the GCAs 250 reside are referred to herein as client computers. For the sake of simplicity, the preferred embodiment described herein contains one GSA 150 executed by one server computer, but it should be understood that the present invention may contain multiple GSAs 150 running on one or more server computers. The network 105 may be the public internet network or another public or private, local or wide area network. For example, network 105 could be a wireless network, such as a Bluetooth network. Also shown in FIG. 1 is the GSA 150 connected by a network 100 to a plurality of networked Real-Time Data Source Providers 200. The network 100 may be the public internet network or another public or private, local or wide area network. The Real-Time Data Source Providers 200 are preferably network accessible dynamic information portals which are provided as a service by a variety of third party companies and organizations, such as weather data from The Weather Channel, the world date and time server by Chaos Software Group, or any other desirable type of information.

The architecture of the GSA 150 preferably comprises an Authentication Module 170, a Real-Time Data Collection Module 175, a Game Client Interface Module 190, a Game World Context Module 180, and a Server Game-Type Module Framework 185 wherein a number of Server Game-Type Modules 165 are inserted. These sub-components of the GSA 150 need not be realized in the same executable application or instantiated on the same physical computer processor, but may be realized using a plurality of applications and services running on a plurality of computer processors. The Authentication Module 170 preferably maintains a database 155 of registered users to validate users of the system when they log in to play.

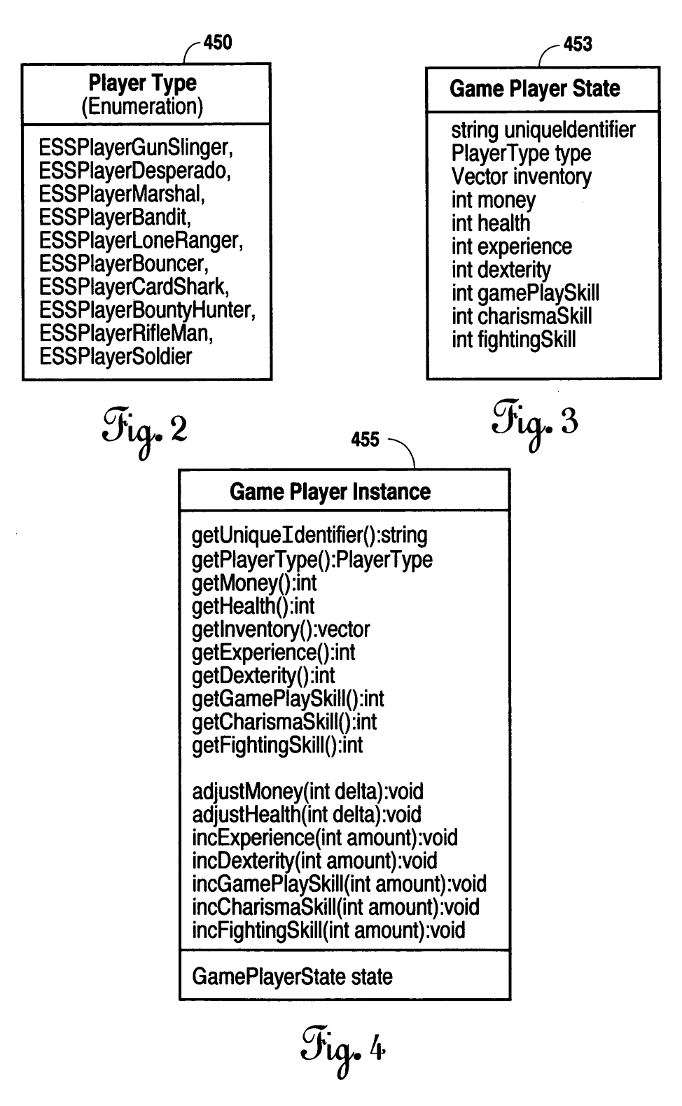

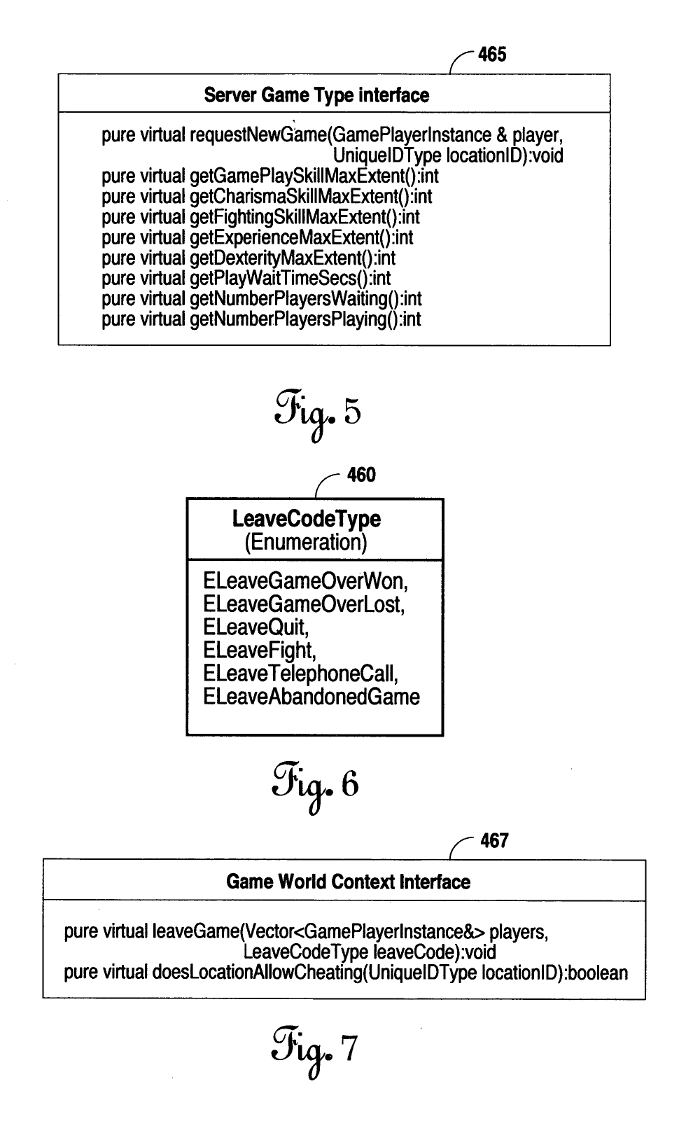

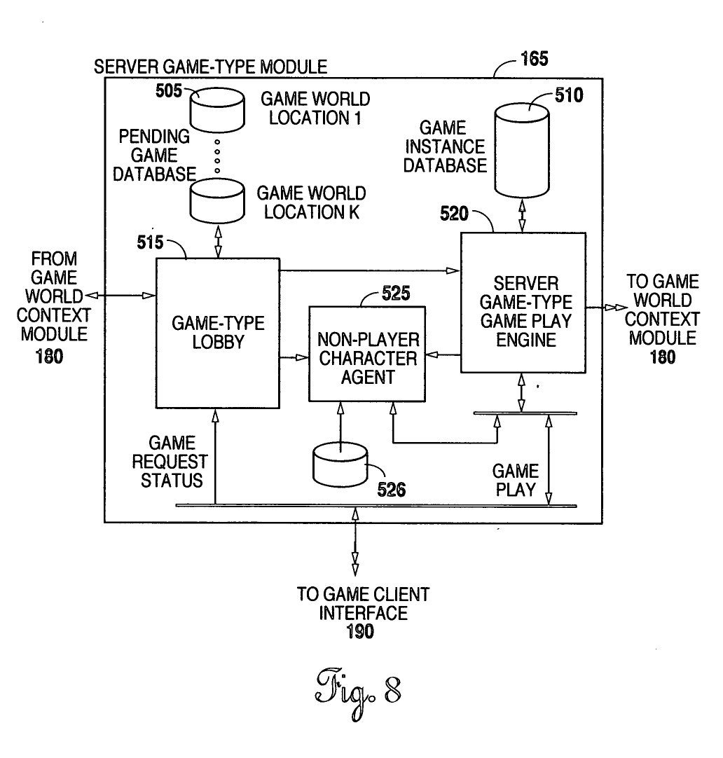

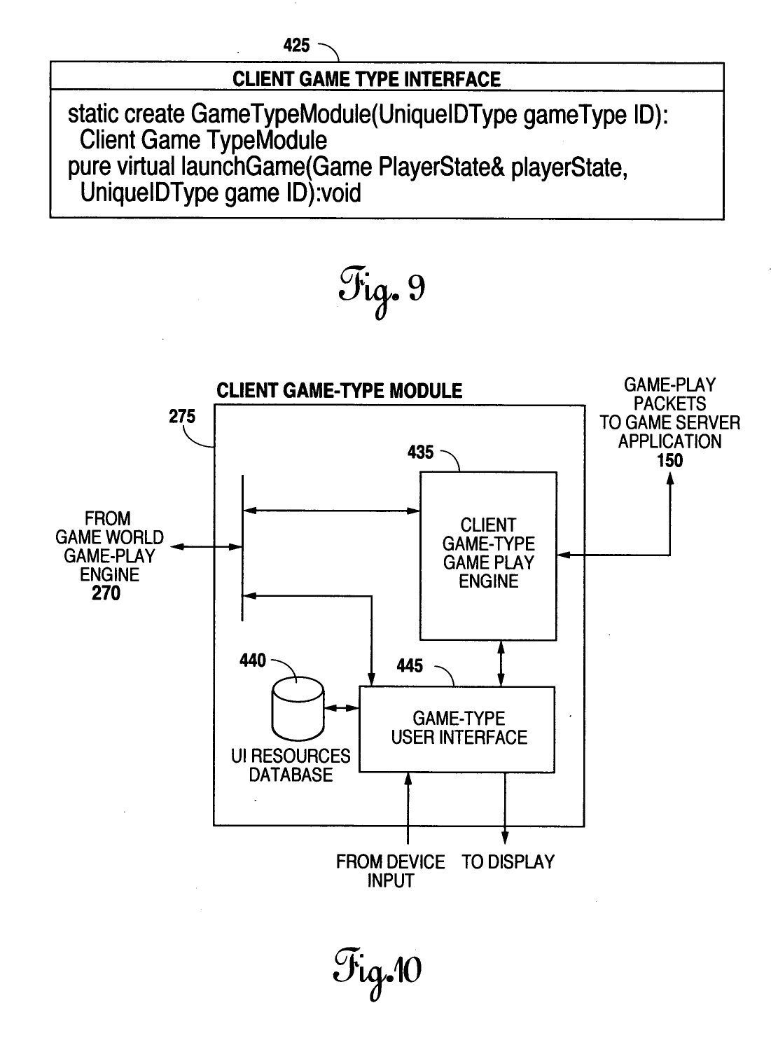

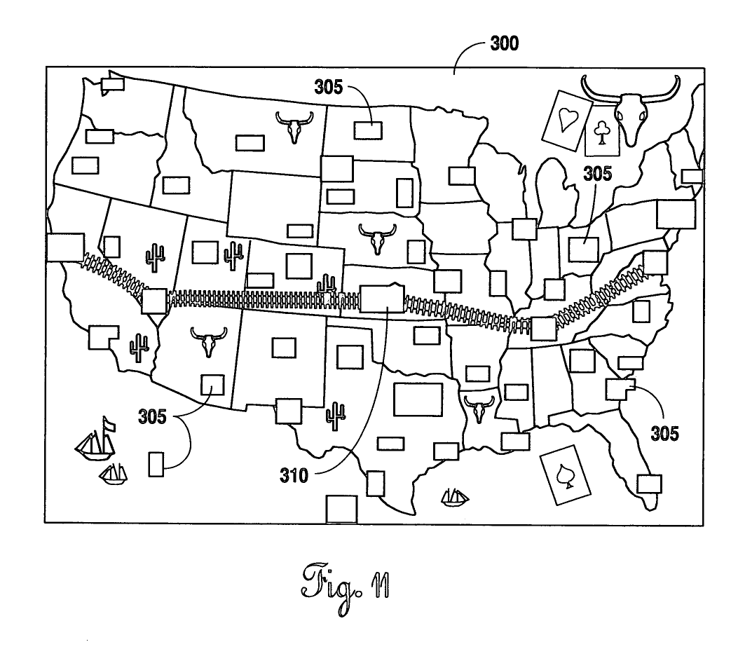

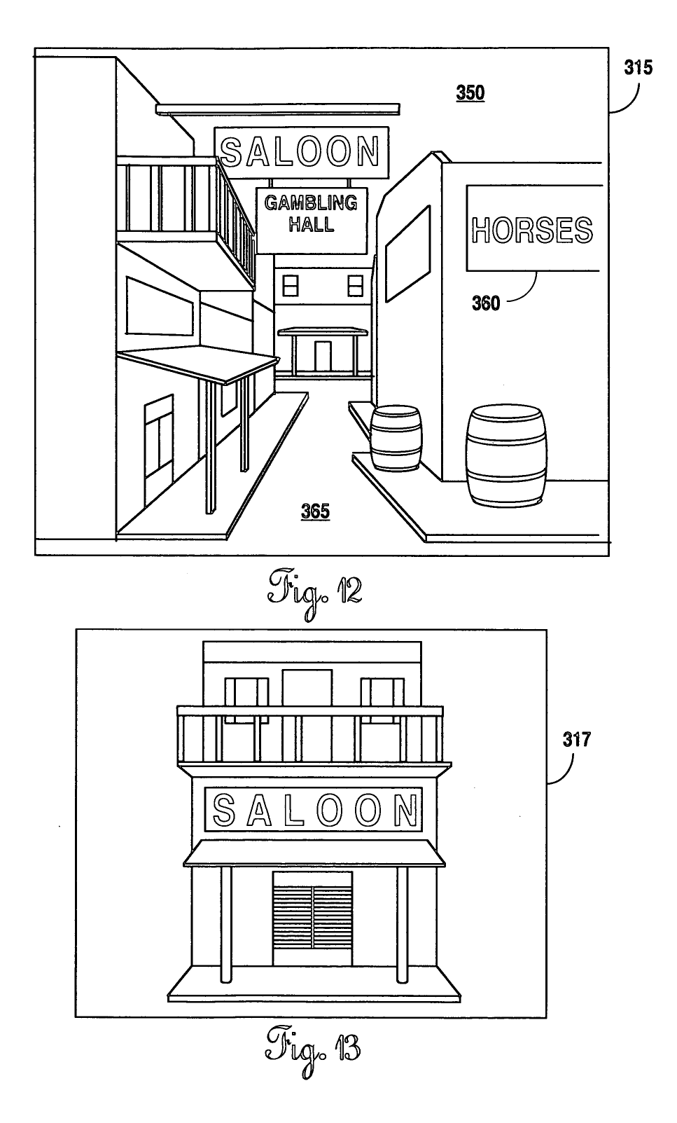

Referring now to the GSA 150 of FIG. 1, the Game World Context Module 180 provides a means for maintaining and providing game play in an encompassing, homogeneous virtual Game World in which the game players exist and interact in an ongoing game. The virtual Game World is ongoing, or persistent, in the sense that each player may “log in” to and “log out” from the Game World from time to time while maintaining a continuous yet dynamic virtual identity, as described further below. Throughout the ongoing game, the Game World Context Module 180 maintains and references the persistent states of each player in a Game World Context database 160. FIG. 3 illustrates an example class diagram for a Game Player State 453 that includes static properties identifying the player, such as a unique identifier and a Player Type selected from a Player Type Enumeration 450 of FIG. 2, as well as variable properties that preferably change continually throughout the game, such as money, health, skills, experience, dexterity, charisma, and inventory, for example. Such static and dynamic properties associated with each player are referred to herein as attributes, which collectively constitute a virtual identity for each player. It should be appreciated that the attributes mentioned herein are merely examples, and other attributes are possible within the scope of this invention. The game play aspects of the Game World Context Module 180 that interact with and manipulate the Game Player States 453 are of the same nature as role playing games and their design and implementation are well known in the art.

Referring again to the GSA 150 of FIG. 1, the Server Game-Type Module Framework 185 provides a framework for developing a plurality of Server Game-Type Modules 165 that have relevance to the context of the Game World defined and implemented by the Game World Context Module 180. Each Server Game-Type Module 165 preferably implements its own unique and distinct multi-player game and has an associated unique Game-Type ID so that it can be addressed by the Game World Context Module 180 and the GCA's 250. The Server Game-Type Module Framework 185 preferably provides multiple portals to the same multi-player Game-Types mapped out across various locations in the Game World. Preferably, all interactions with GCAs 250 that are relevant to the Server Game-Type Modules 165 are properly funneled through the Game Client Interface 190. The plurality of Server Game-Type Modules 165 may be implemented within the same application or as a separate process, application, or dynamically linked library invoked locally or remotely.

Referring now to FIGS. 4-7, the relevance provided by the Server Game-Type Module Framework 185 of FIG. 1 is accomplished by the Game Player Instance 455 (see FIG. 4), the Server Game-Type Interface 465 (see FIG. 5), and the Game World Context Interface 467 (see FIG. 7). The Game Player Instance 455 provides methods to access and modify certain properties of the Game Player State 453 (see FIG. 3). When passed into the Server Game-Type Module 165 from the Game World Context Module 180, Game Player Instance 455 allows the Game-Type game play to take variable courses of action based on the player's Game Player State 453 and provides methods to make impacts or changes on the same. The Server Game-Type Interface 465, implemented by the Server Game-Type Module 165, enables the Game World Context Module 180 to initiate a game request specifying the aforementioned Game Player Instance 455 and a Game World location ID. The Game World location ID specifies a unique portal offered by the Game World, to distinguish this portal from other portals in the Game World of the same Game-Type. The remaining methods of the Server Game-Type Interface 465 serve to provide useful information for the player regarding the status of the game play within the portal as well as information as to what extent game play may affect some of the attributes of the Game Player State 453. Lastly, a reference to a Game World Context Interface 467, implemented by the Game World Context Module 180, is supplied to the Server Game-Type Module 165. At the end of game play, the leaveGame( . . . ) interface provides a means for the Server Game-Type Module 165 to implement the changes made to the state of the Game Player Instance 455 during game play as well as reflect back the reason for leaving, such as those enumerated by Leave Code Type 460, so that the Game World Context Module 180 then has the opportunity to take specialized action befitting the player's reason for leaving.

FIG. 8 depicts a Server Game-Type Module 165 of FIG. 1 in more detail. A Game-Type Lobby 515 preferably handles all the game requests for this Game-Type from the Game World Context Module 180 using the requestNewGame( . . . ) function within the Server Game-Type Interface 465 (see FIG. 5). As parameters, the requestNewGame( . . . ) function preferably takes a reference to a Game Player Instance 455 and a Game World location ID. At the time of a game request, the Game Player Instance 455 is stored by the Game-Type Lobby 515 into a pending game record in the appropriate Pending Game Databases 505 based on the specified Game World location ID. The remainder of the functionality that the Game-Type Lobby 515 implements, such as handling, pooling, and granting game requests, instantiating a game instance, and the like, can be realized with techniques and implementations available and known in the art.

Still referring to FIG. 8, a Server Game-Type Game Play Engine (SGPE) 520 preferably takes new game instances created by the Game-Type Lobby 515 along with their associated Game Player Instances 455 and maintains them for the duration of the game in a Game Instance Database 510, assigning each new game instance a Unique Game Session ID. The game play ensues amongst the players as coordinated by the SGPE 520 with the GCAs 250 through the Game Client Interface 190. Throughout the course of the game play, the SGPE 520 may access and modify properties of the players' Game Player States 453 in the context of the encompassing Game World by calling methods into the appropriate Game Player Instance 455. At the end of game play for each Game Player Instance 455, the leaveGame( . . . ) interface function of Game World Context Interface 467 is called to indicate the reason for leaving and for implementing any changes of state that may have occurred in the Game Player Instance 455. The logic and sequencing of game play is preferably Game-Type specific and is implemented accordingly. Some examples of Game-Types may include Five Card Draw Poker, Checkers, Chess, a turn based gun fight, or any other desired game. Persons skilled in the art will recognize that the aforementioned games are only examples of the many types of games that may be played in the Game World in accordance with this invention, which is not limited to any particular types of games.

Still referring to FIG. 8, a Non-Player Character (NPC) Agent 525 preferably supplies and maintains computer controlled artificial players in a NPC Player Database 526 to fill in empty player slots of instantiated games as needed at the request of either the Game-Type Lobby 515 or the SGPE 520. The artificial intelligence of the NPC Agent 525 is preferably Game-Type specific, and its implementation is preferably the same as that typically employed in game development as is known in the art. The Game-Type Lobby 515 may employ the NPC Agent 525 to populate slots of a pending game so that the real players may begin play without the delay of waiting for other players to join. The SGPE 520 may employ the NPC Agent 525 if any game player leaves a game prematurely. In the latter case, the NPC Agent 525 is preferably given a copy of the former player's Game Player Instance 455 and all of that player's objects held in connection to the Game-Type game so that the NPC Agent 525 can begin game play with the same state of the player who left, but continue game play using its own artificial intelligence. In this way, the game play can continue for the rest of the players still playing the game. In some cases, the player that had to leave the game prematurely may have been dropped from the game unintentionally, such as when playing from a mobile wireless device where network coverage was momentarily lost or a voice phone call was received during play, for example. In these cases, the player may desire to rejoin the game after regaining network coverage or dropping the received voice call. If this is the case, the Client Game-Type Module 275 (see FIG. 1) may send a “rejoin game” message back to the SGPE 520, with a reference to the original game's Unique Game Session ID. If that game is still in play, then the player will be allowed to rejoin the game, and the resuming player will be given an updated copy of his Game Player Instance 455 and associated Game-Type game objects as maintained by the former NPC player. Finally, the SGPE 520 will inform the NPC Agent 525 to discard and cancel the NPC player. In this way, game play can be resumed when a player was forced to leave a multi-player game prematurely.

Referring again to FIG. 1, the Game Client Interface 190 preferably performs the function of routing Game Play data from the plurality of GCAs 250 to the appropriate server module, namely, the Game World Context Module 180 or one of the Server Game-Type Modules 165. This routing may be performed, for example, by prefixing the request from GCAs 250 with a Destination Descriptor that is equivalent to the unique Game-Type ID associated with the corresponding Server Game-Type Module 165. Setting the Destination Descriptor to the Null value could, for example, indicate the Game World Context Module 180 as the destination. The Game Client Interface 190 also preferably performs the function of routing Game Server Game Play data from the server modules to the appropriate GCA 250. The routing is preferably enabled by maintaining a cache of mappings 192 of each player's UniqueIdentifier of Game Player State 453 to their corresponding GCA 250 network address. The network address of each GCA 250 is acquired using standard and available methods known in the art.

Referring again to FIG. 1, the architecture of the GCA 250 preferably comprises a Game World Game Play Engine 270, a Game World User Interface 280, and a set of Client Game-Type Modules 275. The Game World Game Play Engine 270 preferably has a Game World Portal Location Database 265 that holds a static or dynamic mapping of Game World portal locations to Game-Type ID's specifying which game-type is played in each portal. In this way, portals to a particular Game-Type are mapped to various locations within the Game World. Both the location and the game-type of a given portal may be dynamic. That is, a given game-type may be mapped to multiple locations in the Game World, and a given portal may be mapped to multiple different game-types from time to time. For example, if a certain player has a certain prescribed attribute or combination of attributes, that player may be able to dictate the game-type for a particular portal. When a user navigates to a mapped portal location and elects to enter it, the Game World Game Play Engine 270 submits the request to the GSA 150 for a game of type Game-Type in the specified Game World location. When the game request is granted by the GSA 150, the Game World Game Play Engine 270 preferably passes control to the corresponding Client Game-Type Module 275. The methods for achieving the remaining functionality required of the Game World Game Play Engine 270, such as registering, creation, selection, and deletion of the user' persistent game instances, the game-play logic, flow, navigation, and other dynamics, are well known in the art. The Game World User Interface 280 preferably directs the user's input to the Game World Game Play Engine 270 for processing and continually uses graphical user interface (GUI) elements to represent to the user on his device screen his current location within the Game World as well as the other dynamics that the Game World Game Play Engine 270 wishes to reflect to the user graphically during game play. The Client Game-Type Modules 275 are preferably plug-in mechanisms that provide the program code and user interface elements for implementing a Game-Type multi-player game client. During the game play of the Client Game-Type Module 275 on a user's client computer device, the Client Game-Type Module 275 preferably takes control of the device's user interface and communicates game play over the network 105 to the Server Game-Type Modules 165 via Game Client Interface 190. The Client Game-Type Modules 275 may be implemented as compile-time or run-time plug-ins using the same or separate dynamically linked libraries or applications deployed over local or network connections.

FIG. 10 shows a more detailed view of a preferred Client Game-Type Module 275 of FIG. 1. The Client Game-Type Module 275 implements the Client Game-Type Interface 425 (see FIG. 9) and contains a Client Game-Type Game Play Engine 435 and a Game-Type User Interface 445. The Client Game-Type Interface 425 of FIG. 9 supplies a mechanism for the Game World Game Play Engine 270 of FIG. 1 to create an instance of a desired Client Game-Type Module 275. One possible implementation defines a static factory function createGameTypeModule( . . . ) that creates an instance of the correct Client Game-Type Module 275 when given a unique identifier specifying the Game-Type. The Client Game-Type Interface 425 also specifies a launch Game( . . . ) interface that each Client Game-Type Module 275 implements. Through this interface, the Client Game-Type Module 275 receives a local client copy of the Game Player State 453 and a Game ID uniquely representing the granted game session for the server. During the course of the Game-Type game play, the Client Game-Type Game Play Engine 435 interacts with the user using the Game-Type User Interface 445 and coordinates the Game Play with the Server Game-Type Game Play Engine 520 of FIG. 8 over the supplied network 105, preferably via Game Client Interface 190. The supplied Game Player State 453 allows the Game-Type User Interface 445 to render graphical elements from database 440 on the user's screen, reflecting relevant properties of the player in the encompassing Game World into the context of the newly launched game of the Client Game-Type Module 275.

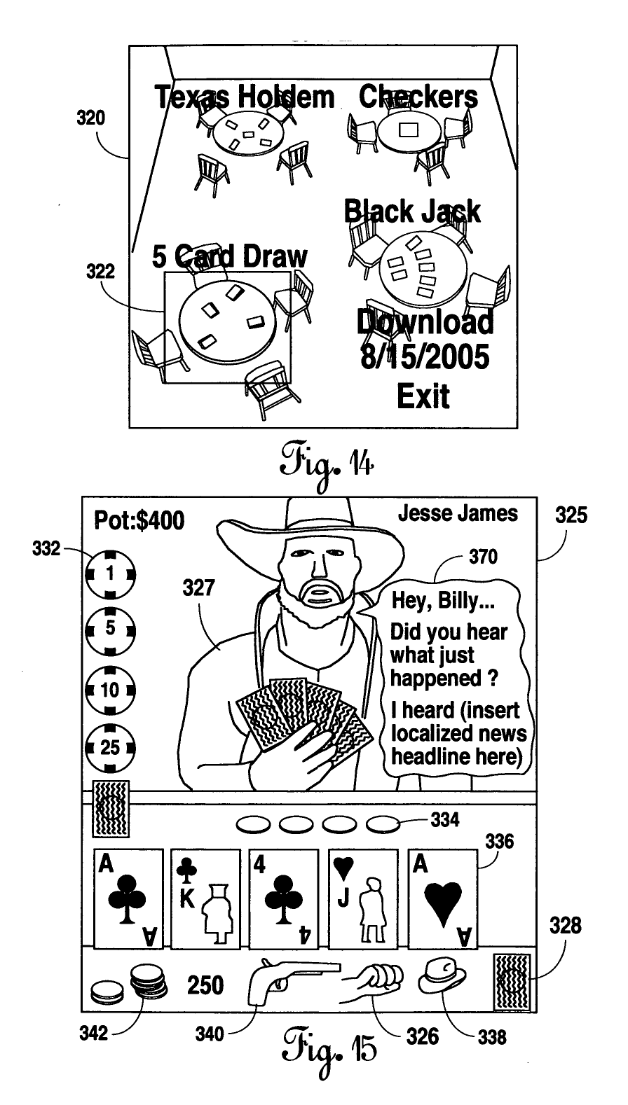

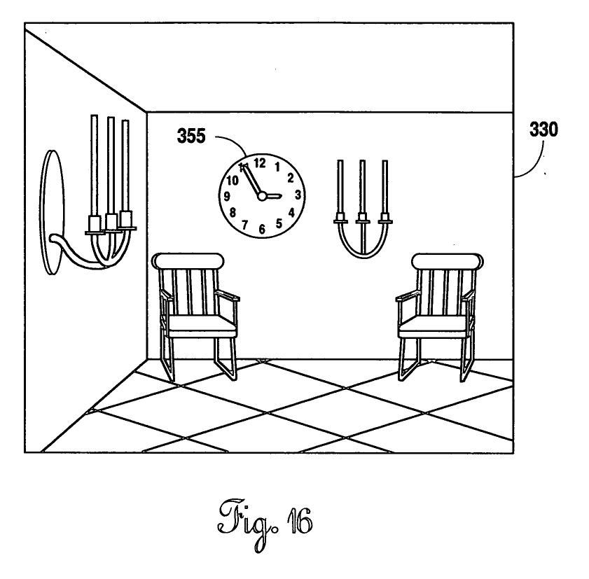

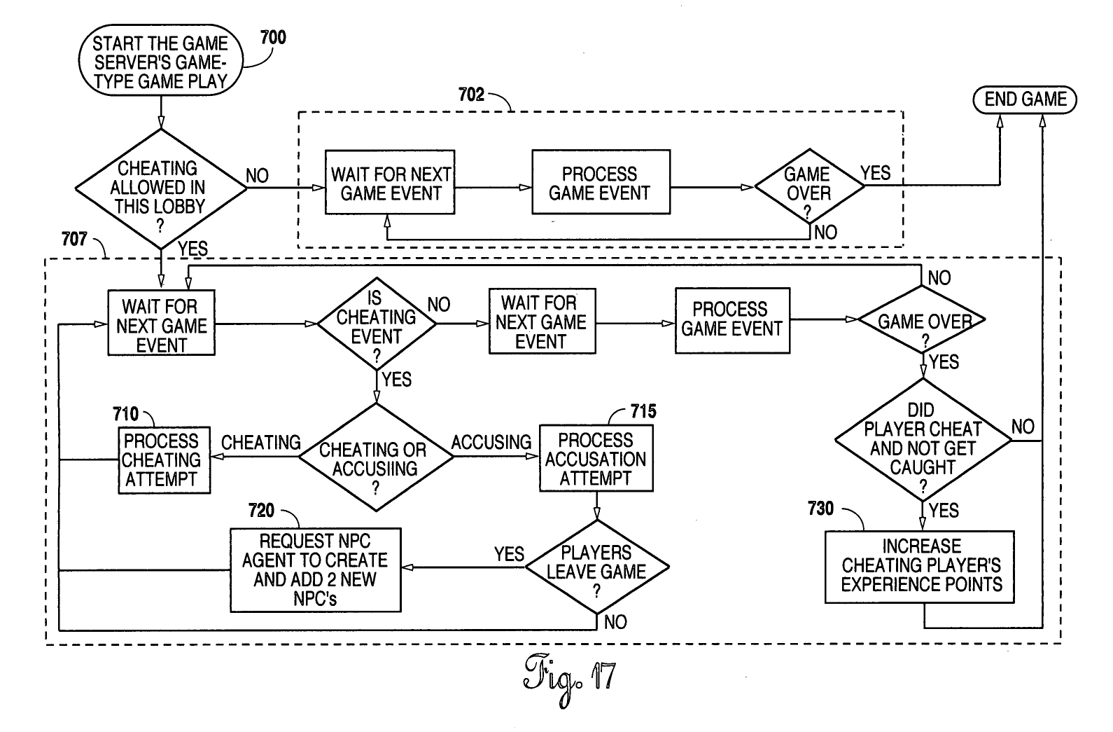

FIGS. 11-16 illustrate possible representations of the graphical user interface framework as experienced by the user provided by the Game Client Application 250 of FIG. 1. The graphical map 300 of FIG. 11 is a user interface element that illustrates a high level view of a Game World. The Game World Game Play Engine 270 processes the user input from the Game World User Interface 280 to move the player around the Game World as indicated in this case by element 310. At each location to which the player navigates, the Game World Game Play Engine 270 evaluates the location entry in the Game World Portal Location Database 265 to see if the location is a portal to a game provided by a Client Game-Type Module 275. In the example shown in FIG. 11, the user may navigate between and among the various locations indicated by boxes 305. Further navigation into the selected location may take the user to other views such as those shown in FIGS. 12-16, which show increasingly more detail. For example, when navigating to a Saloon 317 in Fort Worth, Texas as shown in FIG. 13, the player may find a set of four tables 322 as shown on screen 320 of FIG. 14. In this example, each table 322 is preferably a portal to a different sub-game. Thus, a given game location may comprise a room within a building on a street within a city, just as in the real world. At this point, when the user selects to navigate to a particular table 322, the Game World Game Play Engine 270 finds an entry in the Game World Portal Location Database 265 for a Game-Type of Five Card Draw Poker, for example, at this location. Game World Game Play Engine 270 then makes a game request for Five Card Draw Poker at the Saloon 317 in Forth Worth, Texas to the Game World Context Module 180 of the Game Server Application 150. Using the Server Game-Type Module Framework 185, the request is passed to the Server Five Card Draw Module 165 and the player is placed in the Forth Worth, Texas Saloon lobby to await the next available game. After the game request is granted, the Game World Game Play Engine 270 is notified and, using the provided interfaces, it instantiates the Client Five Card Draw Poker Module 275. Then, program control is transferred to the Client Five Card Draw Poker Module 275 and the game play begins between the Client Five Card Draw Poker Game Play Engine 435 of FIG. 10 and the Server Five Card Draw Poker Game Play Engine 520 of FIG. 8. The user is now placed into the game to begin play by the Five Card Draw Poker User Interface 445 of FIG. 10 as illustrated by player character 327 in screen 325 of FIG. 15.

FIG. 17 shows a software flow diagram for an implementation of a Server Game-Type Game Play Engine (SGPE) 520 in the Server Game-Type Module 165 of FIG. 8 that provides an exemplary method for enabling cheating in multi-player games in an attractive way. In general, cheating becomes an attractive dimension to game play when at least some, and preferably all, of the following characteristics are met:

(1) Playing a game where cheating is enabled is optional for a player.

(2) There is a mechanism for a player to cheat and there is a mechanism for a player to accuse another of cheating.

(3) The frequency of cheating is constrained to some maximum extent.

(4) The cheating game players have some virtual identity outside the particular game, but within the virtual Game World, whereby certain preconditions for cheating must be earned and obtained before a player becomes capable of cheating. That is, not just anyone can come in a game and start cheating.

(5) When a certain player attempts to cheat, there is a mechanism for the remaining game players to be given a hint that may be more or less noticeable, depending in part on the actual perceptiveness of each player, as well as enabling attributes of the perceiving player' virtual identity outside the particular game. In other words, there is a way for players to detect, or think they detect, another player cheating based on how perceptive they are.

(6) The cheating game players have some virtual identity outside the particular game, but within the virtual Game World, so that when a player elects to cheat, there is a chance that his virtual identity can be affected in a negative way or a positive way. In other words, cheating may have consequences—possibly good, possibly bad.

(7) The accusing game players have some virtual identity outside the particular game, but within the virtual Game World, so that when a player elects to accuse a fellow player of cheating, falsely or not, there is a chance that his virtual identity can be affected in a negative way or positive way. That is, accusing someone of cheating and taking them to task may have consequences—possibly good, possibly bad.

(8) There is a chance that the accuser and the accused will not be able to settle the dispute agreeably in a short amount of time, and the players may elect to abandon the particular game in which the dispute arose in order to settle their differences in a separate one on one game. To avoid any unpleasant disruption or delay of these sorts in the game play for the other players, a mechanism is preferably provided for temporary artificial Non-Player Characters to be substituted into the game and take over game play for the absent players as needed.

The portions of characteristics (4), (5), (6), and (7) above that require the players to have a virtual identity outside of the particular game but within the virtual Game World are satisfied by the system 10 shown in FIG. 1 and described above. The SGPE 520 is able to interact with each player's virtual identity using its reference to access and manipulate attributes of each player's Game Player Instance 455 (see FIG. 4).

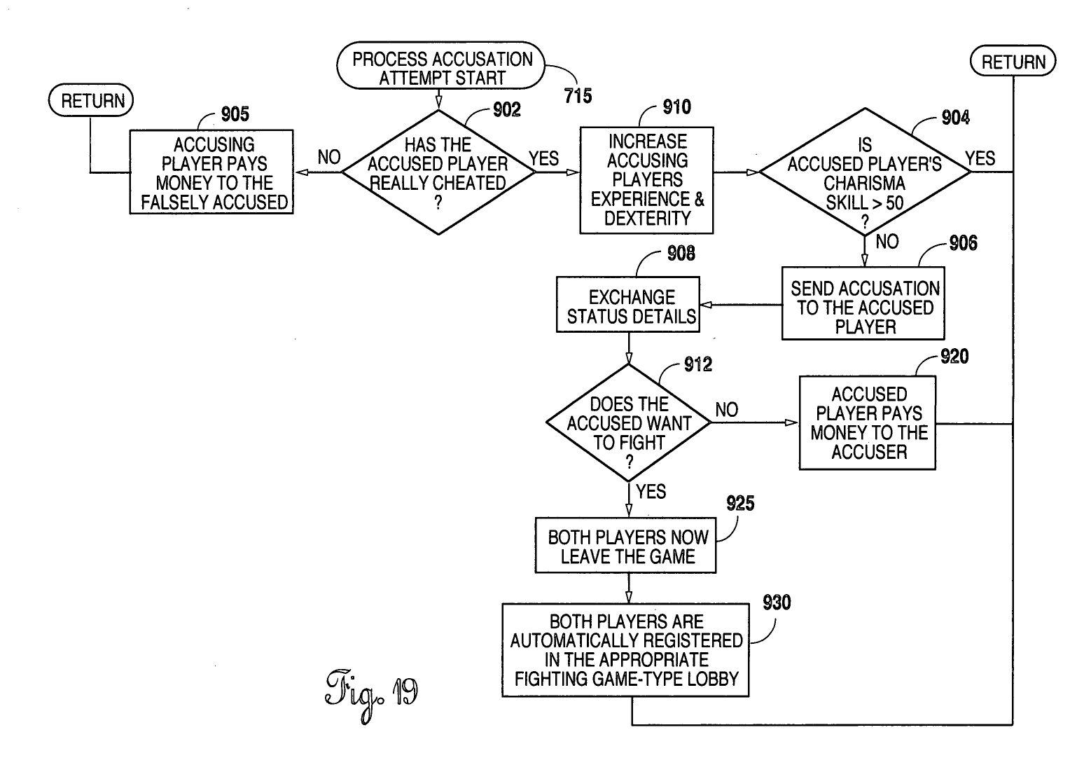

Characteristic (1) is satisfied by a user interface framework of the GCA 250 that can map portals to the same Game-Type across various locations throughout the Game World. One portal location for a given Game-Type may provide access to a game where cheating is allowed, while other portal locations of the same Game-Type may provide access to a game where cheating is not allowed. The cheating condition is preferably handled according to the method illustrated in FIG. 17. When the game play starts at point 700, the SGPE 520 may query the Game World Context Module 180 of FIG. 1 using the doesLocationAllowCheating( ) function of the Game World Context Interface 467 of FIG. 7. If the location does not allow cheating, then game play ensues normally as shown in the sequence of mode 702. If the location does allow cheating, then the game play is controlled by the sequence shown in mode 707. Characteristic (2) is satisfied in the case of mode 707. In mode 707, the SGPE 520 processes each normal game event for the duration of the game in the same manner as mode 702, except that if a cheat event of type “cheating” or “accusing” is detected by a player in the game play, then the appropriate process 710 or 715, respectively, is invoked. A method is provided for the processes 710 and 715 in the flow diagrams of FIG. 18 and FIG. 19, respectively.

Referring now to FIG. 18, a method for the Process Cheating Attempt 710 is provided. The implementation chosen to illustrate this method is a unique method of cheating provided for Poker card games. Characteristic (3) is satisfied by a condition such as that in block 800, for example, in which cheating may or may not be allowed dependent upon whether the player has already cheated in the particular game. Characteristic (4) is satisfied within the method of block 805 wherein the requested cheat operation is processed. In this case, certain cheats are allowed based on the cumulative card playing skill earned by the player prior to this point. The card playing skill attribute is accessed by the getGamePlaySkill( ) function of the Game Player Instance 455. If a player wishes to steal from the pot, for example, as shown in decision block 812, if the cheat is allowed, some money (preferably a small amount) is transferred from the pot to the cheating player as indicated in box 828. If the player's card playing skill is greater than 20, for example, as queried in decision block 814, and the player has an ace in his sleeve as queried in decision block 816, then the player is allowed to get any card out of the deck that has not been played as indicated in block 830. If the player's card playing skill is greater than 30, for example, as queried in decision block 818, and the player wishes to share a card with a partner as queried in decision block 820, then the process in circle 1 is carried out. If the card sharing is agreed to by the player's partner as queried in decision block 838, then the player is allowed to look at the partner's cards as indicated in block 840. If the player then wants to pick a card from the partner, as queried in decision block 842, and if such is agreeable by the partner, as queried in decision block 844, then the players are allowed to swap cards as indicated in block 846. Thus, players may conspire together to cheat. If the player's card playing skill is greater than 40, for example, as queried in decision block 822, and the play is a dealer's choice, as queried by decision block 824, then the player is allowed to pick two cards, for example, during the deal as indicated in block 832. If the player's card playing skill is greater than 50, for example, as queried in decision block 826, then the player is allowed to look at another player's cards as indicated in block 834.

Still referring to FIG. 18, characteristic (5) above is satisfied by sending hints to the other players in the game as indicated at block 810 if the player is not allowed to conceal the cheat as queried in decision block 836. The hints may be represented to the user in the user interface in a number or ways. For example, one method would display a message on the screen, giving explicit or implicit suggestions that cheating is going on. These messages on screen may be dithered with messages with similar suggestions that are displayed when no one is actually cheating. As another example, a second method of providing hints to the other players is through graphical representation of the cheating player on the other player's device displays. More specifically, one example may include the view of an opposing player such as image 327 of FIG. 15. During the course of normal game play, the graphical representation of the player may depict habitual or nervous mannerisms. While cheating, the frequencies of these mannerisms may be increased or new types of mannerisms may be introduced. Furthermore, the hints available to the observing players may be more or less likely to be shown to them based on the value of their Game Player State 453 attributes such as experience, dexterity, or game play skill available from the Game Player Instance 455. Persons of skill in the art will appreciate that the foregoing illustrations of cheating and hints of cheating are by way of example only and are not limiting to the present invention.

Referring back to FIG. 17, the positive effect on a player's virtual identity contemplated in characteristic (6) above may be satisfied in a number of ways. First of all, the process 730 preferably executes when a player has cheated but was not caught. In that case, the cheating player's attributes of experience, dexterity, or game play skill available in the Game Player State 453 are increased, thereby increasing the value and potential of the player in other aspects of the game play. Secondly, a more obvious positive effect on a player's virtual identity could be that the benefits of cheating have caused the cheating player to win the game, thus gaining favorable attributes in his Game Player State 453, such as collecting more money or realizing improved health as a result of the win, for example. Persons of skill in the art will appreciate that many other ways of providing positive effects on a player's virtual identity as a result of cheating are possible within the scope of this invention.

Referring now to FIG. 19, a possible method for the Process Accusation Attempt 715 is provided. The implementation chosen illustrates a process that may occur after a player accuses another player of cheating in a game of cards. The method shown satisfies the remainder of characteristic (6) above. In decision block 902, the system queries as to whether the accused player has actually cheated. If the accused player has not actually cheated, then the accusing player may be forced to pay money to the falsely accused player as indicated in block 905. If the accused player has actually cheated, then the accusing player's experience level is preferably increased as indicated in block 910. If the accused player's charisma skill level is greater than 50, for example, then the accused player may not suffer a negative consequence of being caught. In this example, if the accused player's charisma skill level is 50 or less, then an accusation is sent to the accused player as indicated in block 906 and status details of the players are exchanged as indicated in block 908. If the accused player wants to fight, as queried in decision block 912, then both players may leave the game to fight as indicated at block 925, and the accusing player and the accused player are then registered in the appropriate fighting game lobby as indicated at block 930. If the accused player does not want to fight, as queried in decision block 912, then the accused player may be forced to pay money to the accuser as indicated in block 920. Process 920 thus provides a negative effect on virtual identity to a player who cheated and got caught by decreasing the amount of his money attribute in his Game Player State 453. Characteristic (7) is satisfied by processes 910 and 905 which enable both a positive and a negative effect, respectively, to the accuser's Game Player State 453. Lastly, process block 930 provides a further potential for unknown consequences to both of the players, regardless of who is the honest one. In the case of block 925, the players have elected to fight it out, and the players leave the game hosted by the Server Game-Type Module 165. Again, as persons skilled in the art will appreciate, the foregoing illustrations of how to provide positive or negative consequences as a result of cheating or accusing another player of cheating are by way of example and are not limiting to the present invention.

Two players leaving the game to fight is accomplished by the Server Game-Type Module 165 as it calls the leaveGame( . . . ) interface of the Game World Context Interface 467, with the GamePlayerInstance vector containing a reference to the two players, and the leave code indicating EleaveFight from enumeration 460 of FIG. 6. In the remote process of box 930 (see FIG. 19), the Game World Context Module 180, in whatever suitable fashion as may be desirable, joins the two cheating and accusing players together in a fighting game, which could be implemented by the Game World Context Module 180 itself or delegated to a Server 1-on-1 Fighting Game-Type Module 165 where both players play against each other and each stands to gain or lose money, health, inventory, experience, skills, or some other attribute based on the outcome of the game. This feature also helps to satisfy characteristics (6) and (7). Referring also to FIG. 17, characteristic (8) is satisfied by the process 720, in which the Server Game-Type Module 165 employs the Non Player Character Agent 525 of FIG. 8 to create two new artificial Non Player Characters to continue the roles in the game that were left by the two fighting players. Alternatively, the cheating player and the accusing player may not leave the game to settle their dispute and instead they may engage in a fight in the same game while the other players watch them fight. After the fight is over, the game may resume.

Referring again to FIG. 15, the graphical representation of a player 327 in a game environment may take any desirable form. In the example screen 325 of FIG. 15, player 327 is shown in a card game in which various values of chips 332 are available for wagering. Screen 325 also shows the current pot 334, the current amount of the pot ($400 in this example), the current cards 336 held by player 327, and the amount of money 342 ($250 in this example) currently held by player 327. Screen 325 also has selectable buttons 326, 340, and 338. In this example, button 326 may be selected if player 327 wants to make an accusation of cheating against another player that may lead to a fist fight. Similarly, button 340 may be selected if player 327 wants to make an accusation of cheating against another player that may lead to a gun fight. Button 338 may be selected in order to view the current attributes of the virtual identity of player 327. Persons of ordinary skill in the art will recognize that the foregoing example of a graphical representation of a particular game environment is illustrative and not limiting to the present invention.

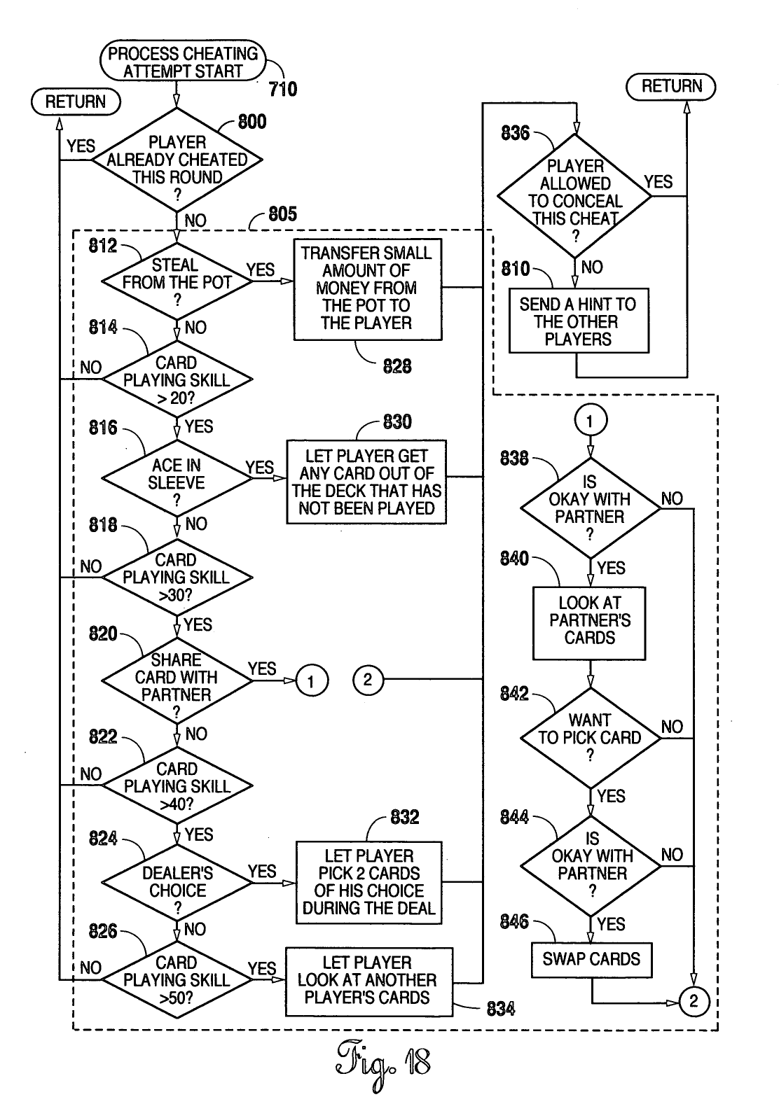

Referring back to FIG. 1, the Real-Time Data Collection Module 175 preferably collects and stores selected real-time information of real world geographical locations. Using standard methods, it fetches the desired information from sets of Third-Party Data Sources 200 over its network connection 100, storing them in a cache 177. The Game World Context Module 180 makes the collected information available to the Game Client Application 250. Through available methods, the client's Game World Game Play Engine 270 preferably ascertains the client's current actual physical location and makes periodic queries for gathered information from database 177 relative to that location. Such location-specific real-world information may include time of day, weather conditions, language, business establishments, advertisements, news headlines, emergency conditions, or any other desirable information. The Game World User Interface 280 then uses this information when desired and relevant to project the current information of the real world into the Game World by using programmatically generated and/or static GUI elements from a database 282 and possibly other visual effects to reflect to the user on his device screen the current real world conditions of his actual physical location. FIGS. 12 and 16 depict graphical illustrations of some of the possible implementations. For example, as shown in FIG. 12, the Game World's outside background or sky 350 can be changed to reflect the current state of the sky in the real world, such as sunny, cloudy, dusk, dawn, or nighttime. Also, programmatic visual effects could be used on the sky 350 and the foreground 365 to simulate the appearance of rain or snow. Signs 360 in the Game World can be used to reflect actual local establishments and advertisements. The ground 365 may show the effects of the wind with blowing grass or tumbleweeds, for example. Indoors, as shown in FIG. 16, other projections of the real world can be made on the Game World such as the calendar date, or the time of day on clock 355. Similarly, as shown in FIG. 15, localized news headlines or alerts may be displayed as indicated by element 370. Persons of skill in the art will recognize that the possibilities for projecting real world information into the Game World are essentially limitless, and the foregoing examples should not be considered limiting for the present invention.

In another possible implementation of a Game World in accordance with the present invention, the graphical user interface element 300 of FIG. 11, which shows a high level map of the Game World, may have various locations that correlate directly onto actual locations in the real world. In this case, rather than requesting the real-world data from a GCA's 250 actual physical location, the Game World Game Play Engine 270 alternatively requests the real-time information for the actual location correlated to the user's current virtual location within the Game World. The Game World User Interface 280 projects the real world data to the client's user interface as described above, except in this case it is reflecting data for the location he has navigated to in the virtual Game World.

In another possible implementation, the graphical map 300 of FIG. 11 may be a user interface element in a separate stand-alone client application that is not in the context of a game. In this case, the user interface element 300 illustrates actual physical locations in the real world, and the method of navigating and selecting locations of interest is used to access portals to location-specific information that is collected by the Real-Time Data Collection Module 175 using a similar mechanism as was demonstrated above.

In another possible implementation, the graphical map 300 of FIG. 11 is a user interface element in a separate stand-alone client application that again is not in the context of a game. In this case, the user interface element 300 illustrates actual physical locations in the real world and the method of navigating and selecting locations of interest is used to access any static location-specific data or information stored or downloadable locally on the device, such as local language dictionaries, stores, restaurants, audible language translators, history, and trivia, or other relevant information.

In still another embodiment, the graphical map 300 of FIG. 11 is a user interface element in a separate stand-alone client application that again is not in the context of a game but preferably runs on a mobile device, such as a cell phone. In this case, the user interface element 300 preferably allows the user to define a user location associated with the user and a predetermined language associated with the user location. Alternatively, the predetermined language could be established by the application; for example, the application may establish a predetermined language based on the user location. The graphical user interface 300 also allows the user to select a target location on the map in order to request location-specific, real-world information associated with the target location. The interface 300 then provides the requested location-specific, real-world information to the user in the predetermined language. For example, a user in the United States may define his user location to be Fort Worth, Tex., and the predetermined language associated with that user location may be English. If the user desires to obtain information concerning restaurants in Paris, France, for example, the user could select Paris, France as the target location, and the interface 300 would then provide the requested restaurant information in the English language. Once again, the foregoing example is illustrative and not limiting to the present invention.

In the Game World described herein, the various game portals may be made available to be entered and played by any player. Alternatively, the availability of some game portals may be contingent upon one or more conditions that must be met. For example, referring to FIG. 14, the Black Jack game portal is indicated to become available at a future date of Aug. 15, 2005, for example, preferably upon payment of a prescribed fee. The availability of a given game portal may be contingent upon any desired condition, such as the payment of a prescribed fee, passage of a certain amount of time, or the acquisition by the player of a certain attribute, for example. Referring to FIG. 1, the Game World Context Module 180 preferably monitors the conditions of availability of the game portals for each user by monitoring the player' attributes from the Game World Context database 160 and/or prescribed authorization entries or flags for each portal for each user stored in the authentication database 155, which preferably contains an indication of whether specific payment has been received from a given player in order to play in a certain game portal. When a given game portal is not available to a particular player, the unavailability may be represented to the player in any desired manner by the Game World User Interface 280, such as with a graphical representation of a locked gate beyond which is another portion of a city or other territory within the Game World, for example. Preferably, the Game World Context Module 180 continuously monitors the availability of all game portals and automatically notifies a player when a given game portal becomes available to that player. As a further variation on game portal availability, the Game-Type Lobby 515 of FIG. 8 for each given Game-Type may provide a player with the option of creating one or more private game portals that may be made available only to that player and possibly other players who are selected by that player or who meet certain criteria established by that player. The Game-Type Lobby 515 may accomplish this option by creating private virtual Game World Locations stored in the Pending Game Database 505 and allowing players to create and view a list of private portals which have been filtered based on certain player attributes of the Game Player Instance 455 (see FIG. 4), for example. Persons of ordinary skill in the art will recognize that the foregoing examples of game availability conditions are exemplary and not limiting to the present invention.

An additional enhancement to the enjoyment of the Game World of this invention may involve an option for one player to taunt another player in a multi-player game. Preferably, taunting messages may be sent in the form of text messages that are graphically displayed for the taunted player, the taunting player, or both. The messages are preferably created and presented to the players by the Game World User Interface 280 of FIG. 1. The messages are preferably sent and received by each Client Game-Type Module 275 interacting with the Server Game Play Engine 520, which distributes the messages among the relevant players of the game. The content of taunting messages may be custom generated by a taunting player or may be predetermined. Alternatively, taunting may take the form of audible sounds or visible gestures that are graphically displayed via the player' characters. As another alternative, if a taunted player's computer processor device 12 has a vibrator, a taunt may be manifested by a vibration in the taunted player's device 12. Preferably, taunting events are allowed only at controlled intervals or upon certain prescribed conditions so as not to become too annoying. The ability for players to taunt one another may be especially useful during times when a game is in a state of no activity or reduced activity, such as when other players are waiting on one player to make a move. Once again, persons of ordinary skill in the art will recognize that the foregoing examples of taunting are exemplary and not limiting to the present invention.

Referring again to FIG. 1, although GSA 150 and GCA 250 have been described above as residing on two different computer processors and communicating via a network, GSA 150 and GCA 250 could reside on the same computer processor, and the Game World could be executed in a single-player mode, if desired. Similarly, the various components of GSA 150 could be implemented as a combined module running on one computer processor or as multiple distributed modules running on more than one computer processor. As another alternative, both GSA 150 and GCA 250 could reside on one computer processor and GCA 250 could also reside on other computer processors to facilitate a multi-player mode. A Bluetooth network, for example, would be conducive to the latter scenario. Also, the various databases described herein may comprise temporary storage memory, permanent storage memory, or a combination of both temporary and permanent storage memory. Because the Game World Context Module 180 is modular with respect to a given Game Player Instance 455 in a preferred embodiment, Game World Context Module 180 may be easily reused in connection with other Game Server Applications 150, if desired.

Although the foregoing specific details describe a preferred embodiment of this invention, persons reasonably skilled in the art will recognize that various changes may be made in the details of this invention without departing from the spirit and scope of the invention as defined in the appended claims. Therefore, it should be understood that this invention is not to be limited to the specific details shown and described herein.

1. An electronic game system comprising:
at least one server computer adaptable for executing a game server application;
said game server application comprising computer readable instructions for creating and managing a virtual world;
said virtual world comprising a plurality of game portals;
each of said plurality of game portals providing access to one or more games;
each of said games being playable by a plurality of players;
said game server application further comprising computer readable instructions for establishing and managing a virtual identity for each of said plurality of players;
said virtual identity comprising one or more attributes utilized by said game server application in managing the play of said games;
a plurality of client computers in communication with said at least one server computer;
each of said plurality of client computers being adaptable for executing a game client application;
said game client application comprising computer readable instructions for enabling a player to selectively play one or more of said games.

2. The game system of claim 1 wherein, for each of said plurality of players, one or more of said attributes of said virtual identity may be modified as a consequence of action taken by the respective player associated with said virtual identity.

3. The game system of claim 1 wherein, for each of said plurality of players, said virtual identity is persistent.

4. The game system of claim 1 wherein, for each of said plurality of players, one or more of said attributes is relevant to a plurality of said games.

5. The game system of claim 1 wherein said plurality of players may interact with one another in playing one or more of said games.

6. The game system of claim 5 wherein two or more of said plurality of players may conspire together.

7. The game system of claim 1 wherein said game server application allows cheating by qualified ones of said plurality of players.

8. The game system of claim 7 wherein said game server application allows accusation of cheating by qualified ones of said plurality of players.

9. The game system of claim 7 wherein said game server application may provide at least one hint of cheating.

10. The game system of claim 9 wherein said at least one hint is provided by a graphical representation of a cheating player that exhibits a nervous mannerism.

11. The game system of claim 5 wherein two of said plurality of players may elect to leave a particular one of said games in order to settle a dispute outside of said particular one of said games.

12. The game system of claim 11 wherein said game server application may substitute a nonplayer character for each of said players who elects to leave.

13. The game system of claim 1 wherein said game server application may substitute a nonplayer character for a player who dropped out of one of said games.

14. The game system of claim 13 wherein said player who dropped out of one of said games may subsequently rejoin said one of said games if said one of said games is still in progress.

15. The game system of claim 1 wherein said plurality of game portals are segregated by location within said virtual world.

16. The game system of claim 1 wherein said plurality of game portals are segregated by game type.

17. The game system of claim 1 wherein said plurality of game portals are segregated by location within said virtual world and by game type.

18. The game system of claim 1 wherein the location of at least some of said plurality of game portals is dynamic.

19. The game system of claim 1 wherein the game type of at least some of said plurality of game portals is dynamic.

20. The game system of claim 1 wherein, for each of said plurality of players, said attributes determine the appearance of a graphical representation of each respective player to the other players.

21. The game system of claim 1 wherein said game client application further comprises a graphical user interface in which said plurality of game portals are located on a virtual geographical map.

22. The game system of claim 21 wherein said virtual geographical map enables a player to navigate to locations comprising rooms within buildings on streets within cities.

23. The game system of claim 1 wherein location-specific real-world information is provided for said games at selected locations in said virtual world.

24. The game system of claim 23 wherein said location-specific real-world information includes information selected from the group consisting of time of day, weather conditions, language, business establishments, advertisements, news headlines, and emergency conditions.

25. The game system of claim 23 wherein said location-specific real-world information corresponds to the actual physical location of each respective player.

26. The game system of claim 23 wherein said location-specific real-world information corresponds to the virtual location to which each respective player has navigated within the virtual world.

27. The game system of claim 1 wherein said game server application allows taunting by qualified ones of said plurality of players.

28. The game system of claim 1 wherein at least one of said plurality of game portals comprises a private game portal.

29. A computer readable medium comprising instructions for managing a multi-player game, said game allowing a player to cheat in said game according to one or more prescribed conditions.

30. The computer readable medium of claim 29 wherein said game comprises a virtual card game.

31. The computer readable medium of claim 30 wherein said virtual card game comprises a virtual poker game.

32. The computer readable medium of claim 29 wherein said game further allows a player to accuse another player of cheating.

33. A computer readable medium comprising instructions for managing a game in a virtual world, said game being adapted to utilize real-time, real-world information associated with real locations at selected locations within said virtual world.

34. The computer readable medium of claim 33 wherein said real-time, real-world information includes information selected from the group consisting of time of day, weather conditions, language, business establishments, advertisements, news headlines, and emergency conditions.

35. The computer readable medium of claim 33 wherein said real-time, real-world information corresponds to the actual physical location of a player of said game.

36. The computer readable medium of claim 33 wherein said real-time, real-world information corresponds to a virtual location to which a player of said game has navigated within said virtual world.

37. An electronic game system comprising:
at least one server computer adaptable for executing a game server application;
said game server application comprising computer readable instructions for creating and managing a virtual world;
said virtual world comprising a plurality of game portals;
each of said plurality of game portals providing access to one or more games;
each of said games being playable by a plurality of players;
said game server application further comprising computer readable instructions for establishing and managing a virtual identity for each of said plurality of players;
said virtual identity comprising one or more attributes utilized by said game server application in managing the play of said games;
at least one client computer in communication with said at least one server computer;
each of said at least one server computer and said at least one client computer being adaptable for executing a game client application;
said game client application comprising computer readable instructions for enabling a player to selectively play one or more of said games.

38. The game system of claim 37 wherein said at least one server computer and said at least one client computer are in communication via a Bluetooth network.

39. An electronic game system comprising:
a computer processor adaptable for executing a game application;
said game application comprising computer readable instructions for creating and managing a virtual world;
said virtual world comprising a plurality of game portals;
each of said plurality of game portals providing access to one or more games selectively playable by a player;
said game application further comprising computer readable instructions for establishing and managing a virtual identity for said player;
said virtual identity comprising one or more attributes utilized by said game application in managing the play of said games.

40. The game system of claim 39 wherein at least one of said games comprises at least one non-player character.

41. A computer readable medium comprising:
a game server application comprising computer readable instructions for creating and managing a virtual world;
said virtual world comprising a plurality of game portals;
wherein at least one of said plurality of game portals is initially unavailable to one or more players and subsequently becomes available to one or more players pursuant to at least one prescribed condition.

42. The computer readable medium of claim 41 wherein said at least one prescribed condition is selected from the group consisting of payment of a prescribed fee, passage of a certain amount of time, and acquisition of a certain attribute by a player.

43. A computer readable medium comprising instructions for:
creating a virtual world representative of the real world;
depicting said virtual world with a graphical user interface comprising a geographical map;
defining a user location associated with a user of said computer readable medium;
said user location having a predetermined language associated therewith;
allowing said user to select a target location on said map;
allowing said user to request location-specific, real-world information associated with said target location; and
providing said location-specific, real-world information to said user in said predetermined language.

44. The computer readable medium of claim 43 wherein said user location corresponds to the real-world location of said user.

45. The computer readable medium of claim 43 wherein said user location corresponds to a virtual location selected by said user.

46. The computer readable medium of claim 43 wherein said predetermined language is selectable by said user.

47. The computer readable medium of claim 43 wherein said predetermined language is established by said computer readable medium.
